(19) United States
(12) Patent Application Publication
(10) Pub. No.: US 2025/0022368 A1
(43) Pub. Date: Jan. 16, 2025

(54) SYSTEM AND METHOD FOR MANAGING VEHICLE CONGESTION

(71) Applicant: GM GLOBAL TECHNOLOGY OPERATIONS LLC, Detroit, MI (US)

(72) Inventors: Zahy Bnaya, Petach Tikva (IL); Ariel Telpaz, Givat Haim Meuhad (IL); Sharon Hornstein, Pardes Hanna (IL)

(73) Assignee: GM GLOBAL TECHNOLOGY OPERATIONS LLC, Detroit, MI (US)

(21) Appl. No.: 18/351,771

(22) Filed: Jul. 13, 2023

(51) Int. Cl. G08G 1/01

(52) U.S. Cl. CPC G08G 1/0141; G08G 1/0129; G08G 1/0133; G08G 1/0145

(57) ABSTRACT

A method of reducing traffic congestion for a road network. The method includes predicting future traffic congestion levels for the road network based on historical traffic congestion levels for the road network. An individual contribution to the future traffic congestion levels for each of a plurality of drivers is predicted based on future routes corresponding to each of the plurality of drivers with the future routes including at least one road segment through the road network. At least one congested road segment is identified based on the future traffic congestion levels for the road network and the plurality of drivers with a highest individual contribution to the at least one congested road segment are identified. The plurality of drivers with the highest individual contributions to the at least one congested road segment are provided a first offer to avoid operating a vehicle on the road network.

### INTRODUCTION

The present disclosure relates to a system and a method for reducing traffic congestion for a road network.

During certain times and days, there may be elevated levels of traffic congestion that a driver of a vehicle may want to avoid. Currently, the driver of the vehicle can receive a travel route from various services that predict arrival time based on current traffic congestion levels for a given destination. However, there is a need to reduce levels of traffic congestion and not just plan the travel route based on levels of traffic congestion.

### SUMMARY

Disclosed herein is a method of reducing traffic congestion for a road network. The method includes predicting future traffic congestion levels for the road network based on historical traffic congestion levels for the road network. An individual contribution to the future traffic congestion levels for each of a plurality of drivers is predicted based on future routes corresponding to each of the plurality of drivers with the future routes including at least one road segment through the road network. At least one congested road segment is identified based on the future traffic congestion levels for the road network and the plurality of drivers with a highest individual contribution to the at least one congested road segment are identified. The plurality of drivers with the highest individual contributions to the at least one congested road segment are provided a first offer to avoid operating a vehicle on the road network.

Another aspect of the disclosure may be where the individual contribution to the future traffic congestion levels is determined based on historical driver route information.

Another aspect of the disclosure may be where the historical driver route information includes at least one of a preferred travel route, travel route timing, vehicle dynamics, or parking information recorded for each of the plurality of drivers associated with a route segment that corresponds to the future routes.

Another aspect of the disclosure may be where the route segment corresponds to a new route segment not found within the historical driver route information.

Another aspect of the disclosure may include predicting driver route information for the new route segment based on the historical driver route information for other route segments in the road network.

Another aspect of the disclosure may be where the first offer includes at least one of monetary compensation or an alternative mode of transportation.

Another aspect of the disclosure may be where identifying the plurality of drivers with the highest individual contribution to the at least one congested road segment includes ranking the plurality of drivers by their individual contribution and providing at least one having a highest ranking the first offer.

Another aspect of the disclosure may be where the first offer is provided to the plurality of drivers having a highest ranking having corresponding future routes through the road network having a highest level of congestion as determined by the future traffic congestion levels.

Another aspect of the disclosure may include determining a first set of the plurality of drivers that accepted the first offer and updating the future traffic congestion levels by removing the individual contribution to the future traffic congestion levels for the first set of the plurality of drivers to determine updated future traffic congestion levels.

Another aspect of the disclosure may include identifying a remaining set of the plurality of drivers that did not accept the first offer having the highest individual contribution to the updated future traffic congestion levels.

Another aspect of the disclosure may include providing the remaining set of the plurality of drivers a second offer if the corresponding future travel routes correspond to at least one congested road segment in the updated future traffic congestion levels.

Another aspect of the disclosure may be where the future traffic congestion levels are defined in terms of a number of vehicles traveling per unit time over a predetermined road segment in the road network.

Another aspect of the disclosure may be where the individual contribution to the future traffic congestion levels for each of a plurality of drivers is defined in terms of a number of vehicles traveling per unit time over a predetermined driver road segment in the road network.

Another aspect of the disclosure may be where the first offer is determined based on a driver utility of travel for each of the plurality of drivers traveling along the at least one congested road segment.

Another aspect of the disclosure may be where the first offer exceeds the driver utility of travel for each of the plurality of drivers traveling along the at least one congested road segment.

Disclosed herein is a non-transitory computer-readable medium embodying programmed instructions which, when executed by a processor, are operable for performing a method. The method includes predicting future traffic congestion levels for the road network based on historical traffic congestion levels for the road network. An individual contribution to the future traffic congestion levels for each of a plurality of drivers is predicted based on future routes corresponding to each of the plurality of drivers with the future routes including at least one road segment through the road network. At least one congested road segment is identified based on the future traffic congestion levels for the road network and the plurality of drivers with a highest individual contribution to the at least one congested road segment are identified. The plurality of drivers with the highest individual contributions to the at least one congested road segment are provided a first offer to avoid operating a vehicle on the road network.

Disclosed herein is a system for reducing traffic congestion on a road network, the system includes a vehicle having a plurality of sensors and a controller in communication with the plurality of sensors. The controller includes a processor and tangible, non-transitory memory on which instructions are recorded. The controller is configured to predict future traffic congestion levels for the road network based on historical traffic congestion levels for the road network. An individual contribution to the future traffic congestion levels for each of a plurality of drivers is predicted based on future routes corresponding to each of the plurality of drivers with the future routes including at least one road segment through the road network. At least one congested road segment is identified based on the future traffic congestion levels for the road network and the plurality of drivers with a highest individual contribution to the at least one congested road segment are identified. The plurality of drivers with the highest individual contributions to the at least one congested road segment are provided a first offer to avoid operating a vehicle on the road network.

### BRIEF DESCRIPTION OF THE DRAWINGS

FIG. 1 is a schematic illustration of an example vehicle.

FIG. 2 illustrates an example method of managing vehicle congestion.

FIG. 3 illustrates an example driver utility versus congestion graph.

FIG. 4 illustrates an example driver utility versus offer graph.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

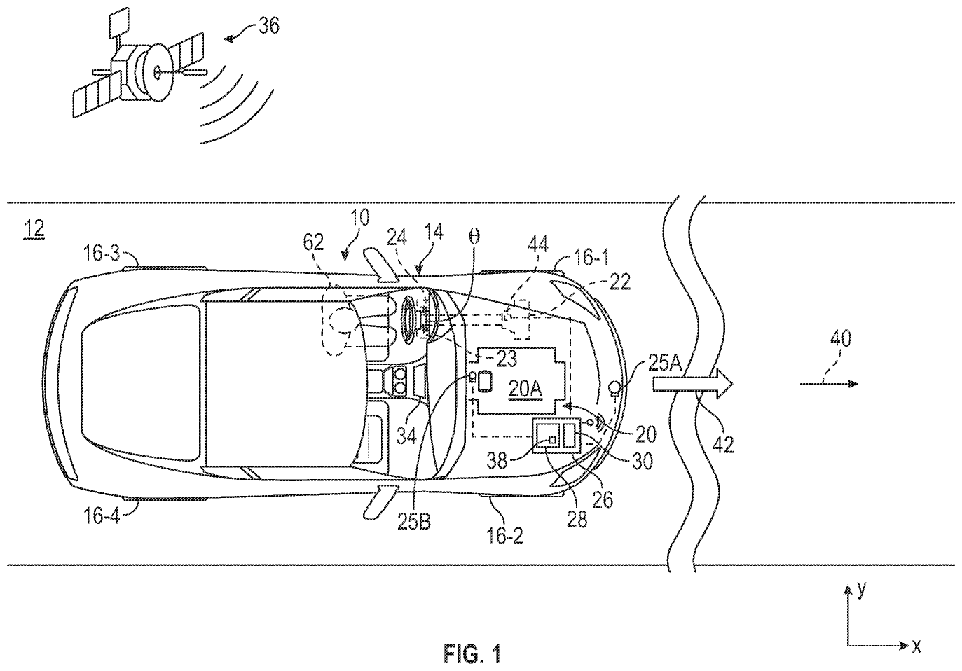

Referring to the FIGS., wherein like numerals indicate like parts referring to the drawings, wherein like reference numbers refer to like components, FIG. 1 shows a schematic view of a motor vehicle 10 positioned relative to a road surface, such as a vehicle lane 12. As shown in FIG. 1, the vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide fictional contact with the vehicle lane 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the vehicle lane 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators 22 (for example, an electrical power steering unit) configured to steer the road wheels 16-1, 16-2, a steering angle (0), an accelerator device 23 for controlling power output of the power-source(s) 20A, a braking switch or device 24 for retarding rotation of the road wheels 16-1 and 16-2 (such as via individual friction brakes located at respective road wheels), etc.

As shown in FIG. 1, the motor vehicle 10 includes at least one sensor 25A and an electronic controller 26 that cooperate to at least partially control, guide, and maneuver the vehicle 10 in an autonomous mode during certain situations. As such, the vehicle 10 may be referred to as an autonomous vehicle. To enable efficient and reliable autonomous vehicle control, the electronic controller 26 may be in operative communication with the steering actuator(s) 22 configured as an electrical power steering unit, accelerator device 23, and braking device 24. The sensors 25A of the motor vehicle 10 are operable to sense the vehicle lane 12 and monitor a surrounding geographical area and traffic conditions proximate the motor vehicle 10.

The sensors 25A of the vehicle 10 may include, but are not limited to, at least one of a Light Detection and Ranging (LIDAR) sensor, radar, and camera located around the vehicle 10 to detect the boundary indicators, such as edge conditions, of the vehicle lane 12. The type of sensors 25A, their location on the vehicle 10, and their operation for detecting and/or sensing the boundary indicators of the vehicle lane 12 and monitor the surrounding geographical area and traffic conditions are understood by those skilled in the art, are not pertinent to the teachings of this disclosure, and are therefore not described in detail herein. The vehicle 10 may additionally include sensors 25B attached to the vehicle body and/or drivetrain 20.

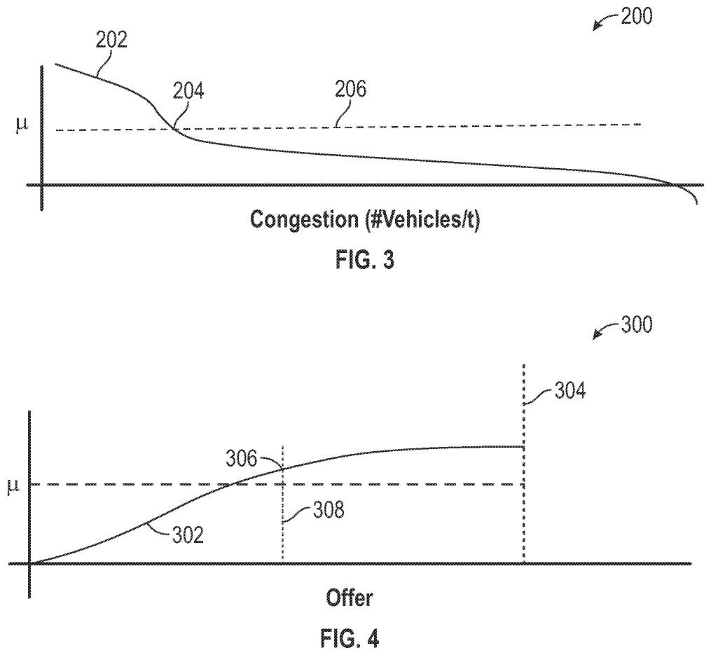

The electronic controller 26 is disposed in communication with the sensors 25A of the vehicle 10 for receiving their respective sensed data related to the detection or sensing of the vehicle lane 12 and monitoring of the surrounding geographical area and traffic conditions. The electronic controller 26 may alternatively be referred to as a control module, a control unit, a controller, a vehicle 10 controller, a computer, etc. The electronic controller 26 may include a computer and/or processor 28, and include software, hardware, memory, algorithms, connections (such as to sensors 25A and 25B), etc., for managing and controlling the operation of the vehicle 10. As such, a method, described below and generally represented in FIG. 3, may be embodied as a program or algorithm partially operable on the electronic controller 26. It should be appreciated that the electronic controller 26 may include a device capable of analyzing data from the sensors 25A and 25B, comparing data, making the decisions required to control the operation of the vehicle 10, and executing the required tasks to control the operation of the vehicle 10.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 26 includes a tangible, non-transitory memory 30 on which computer-executable instructions, including one or more algorithms, are recorded for regulating operation of the motor vehicle 10. The subject algorithm(s) may specifically include an algorithm configured to monitor localization of the motor vehicle 10 and determine the vehicle's heading relative to a mapped vehicle trajectory on a particular road course to be described in detail below.

The motor vehicle 10 also includes a vehicle navigation system 34, which may be part of integrated vehicle controls, or an add-on apparatus used to find travel direction in the vehicle. The vehicle navigation system 34 is also operatively connected to a global positioning system (GPS) 36 using an earth orbiting satellite. The vehicle navigation system 34 in connection with the GPS 36 and the above-mentioned sensors 25A may be used for automation of the vehicle 10. The electronic controller 26 is in communication with the GPS 36 via the vehicle navigation system 34. The vehicle navigation system 34 uses a satellite navigation device (not shown) to receive its position data from the GPS 36, which is then correlated to the vehicle's position relative to the surrounding geographical area. Based on such information, when directions to a specific waypoint are needed, routing to such a destination may be mapped and calculated. On-the-fly terrain and/or traffic information may be used to adjust the route. The current position of a vehicle 10 may be calculated via dead reckoning—by using a previously determined position and advancing that position based upon given or estimated speeds over elapsed time and course by way of discrete control points.

The electronic controller 26 is generally configured, i.e., programmed, to determine or identify localization 38 (current position in the X-Y plane, shown in FIG. 1), velocity, acceleration, yaw rate, as well as intended path 40, and heading 42 of the motor vehicle 10 on the vehicle lane 12. The localization 38, intended path 40, and heading 42 of the motor vehicle 10 may be determined via the navigation system 34 receiving data from the GPS 36, while velocity, acceleration (including longitudinal and lateral g's), and yaw rate may be determined from vehicle sensors 25B. Alternatively, the electronic controller 26 may use other systems or detection sources arranged remotely with respect to the vehicle 10, for example a camera, to determine localization 38 of the vehicle relative to the vehicle lane 12.

As noted above, the motor vehicle 10 may be configured to operate in an autonomous mode guided by the electronic controller 26 to transport an occupant or driver 62. In such a mode, the electronic controller 26 may further obtain data from vehicle sensors 25B to guide the vehicle along the desired path, such as via regulating the steering actuator 22. The electronic controller 26 may be additionally programmed to detect and monitor the steering angle (0) of the steering actuator(s) 22 along the desired path 40, such as during a negotiated turn. Specifically, the electronic controller 26 may be programmed to determine the steering angle (0) via receiving and processing data signals from a steering position sensor 44 (shown in FIG. 1) in communication with the steering actuator(s) 22, accelerator device 23, and braking device 24.

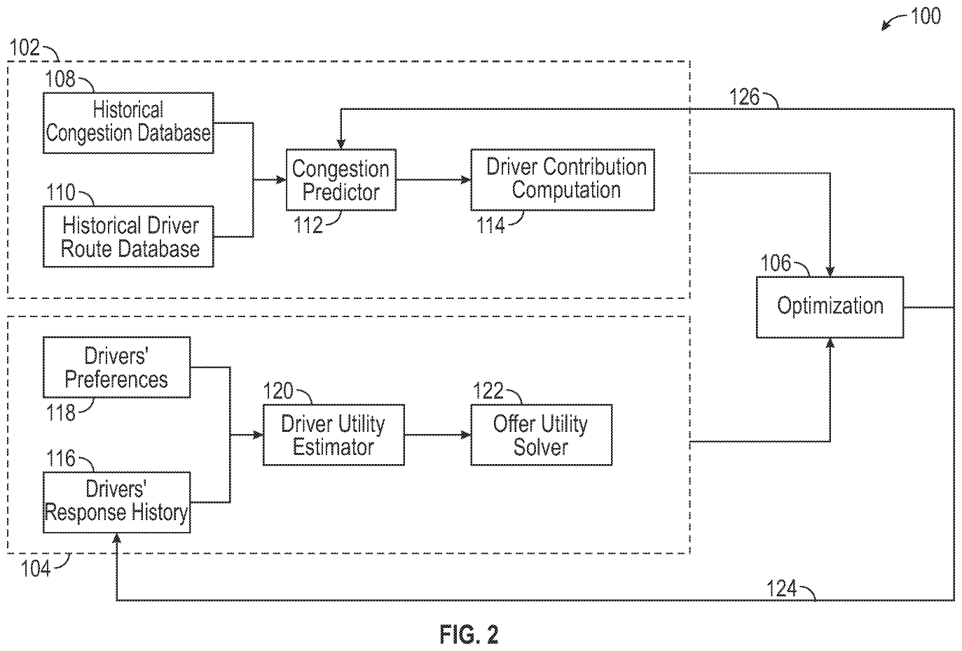

FIG. 2 illustrates a method 100 of reducing traffic congestion for a road network. The method 100 predicts a driver's individual contribution to traffic congestion (Block 102) and determines at least one offer (Block 104) that will prevent the driver from operating a motor vehicle, such as the motor vehicle 10, on the roadway. With the determination of the driver's individual contribution to future traffic congestion levels for a road network and the determination of the at least one offer, the method 100 performs an optimization (Block 106) that minimizes a cost associated with the offers provided to generate the largest reduction in traffic congestion for the road network at the lowest cost. In one example, the method 100 will iteratively provide drivers with an offer not to operate a motor vehicle on the road network. The iteration will continue until each of the drivers accepts an offer, the future traffic congestion levels are below a predetermined traffic congestion level, or a limit on total offers provided has been reached. For example, the limit on offers may be reached when an available pool of monetary compensation has been fully dispersed to the drivers.

The prediction of the drivers' individual contribution to the future traffic congestion levels at Block 102 includes obtaining historical congestion information from a historical congestion database (Block 108). The historical congestion information includes traffic congestion information regarding a plurality of different road segments forming the road network. The historical congestion information can include traffic congestion levels defined in terms of a number of vehicles traveling per unit time over a predetermined road segment in the road network. The historical traffic information can also include variations in congestion levels in relation to a specific day of the week, time of day, or for a particular holiday. The road segments forming the road network can include a predetermined length of a roadway from the historical congestion database (Block 108) that includes similar properties, such as designated speed, road type, or length. The method 100 uses the historical congestion information (Block 108) to predict future traffic congestion levels (Block 110) defined in terms of a number of vehicles traveling per unit time over a predetermined road segment in the road network.

The drivers' individual contribution to future traffic congestion levels predicted at Block 102 also includes obtaining information from a historical driver route database (Block 110) that includes historical driver route information regarding trips taken by the drivers along various road segments in the road network. The historical driver route information can include at least one of a routine travel route, travel route timing, vehicle dynamics, or parking information. In one example, the route timing can include a departure time, a trip duration, or a day of the week. In one example, the above driver route information is obtained through collected GPS coordinate data and sensor data from the sensors 25A,25B on a vehicle corresponding to each of the drivers.

The parking information could include the length of time the driver spent finding a parking spot if the driver double parked the vehicle 10 or if the driver blocked multiple parking spots when parked. This information can be obtained from the sensors 25A, 25B by analyzing images of an area surrounding the vehicle 10 when parked to determine if a portion of the road segment is blocked or if the vehicle 10 is blocking multiple parking spots. The sensors 25A, 25B and GPS coordinates can also be used in determining how long it took the driver to park once within a predetermined distance from a final destination.

The vehicle dynamics can include at least one of velocity, speed profile, acceleration/deceleration profiles, response times to leading vehicles, a headway gap, left lane usage, and cooperation with other vehicles, such as allowing other vehicles to merge between lanes of traffic. One feature of this disclosure is improved historical driver route information by utilizing information obtained from the sensors 25A, 25B directly on the vehicle 10 as opposed to a mobile device within the vehicle 10. This allows for a greater ability to determine if a driver displays certain behaviors that can contribute to increased traffic congestion such as the vehicle dynamics identified above.

The method 100 performs congestion predictions at Block 112 from the information obtained in Blocks 108 and 110. The congestion predictions can include future traffic congestion levels for the road network. In one example, the prediction of future traffic congestion levels can be determined by analyzing the historical congestion database at Block 108 and predicting the future traffic congestion levels based on historic traffic congestion along a corresponding road segment at a given time of day during a week.

The congestion prediction determined at Block 112 can also include a future individual driver congestion prediction at the predetermined future time. The future individual driver congestion prediction can be determined for a road segment per time unit for each of the individual drivers from the historical driver route database at Block 110. The future individual driver traffic congestion prediction can be determined by analyzing the above identified vehicle dynamics obtained from the historical driver route database at Block 110 and predicting how each of the individual drivers will contribute to traffic congestion along the given road segment at the predetermined future time. In one example, the future individual driver congestion prediction includes matching units to the future congestion prediction for allowing comparison of the two numbers.

At Block 114, each of the drivers' individual contribution to the future prediction of traffic congestion is computed for a given route to be traveled in the future by one of the drivers. The individual contribution to future traffic congestion will define an effect for each of the drivers on the future prediction of traffic congestion. In one example, the effect is defined based on scores calculated for the driver along the given route at the future time.

Several different approaches can be used for the computation of the contribution for each of the drivers to congestion depending on the information available. In one example, if the historical driver route database (Block 108) includes information for the driver along the given route, Block 112 can compute the driver's contribution to traffic congestion along the given route by comparing the future individual driver congestion prediction to the future traffic congestion prediction. Block 112 can then output the driver's contribution to congestion for the given route. Block 112 will analyze the above identified vehicle dynamics and determine if a driver with those vehicle dynamics operating a vehicle along that route would increase the level of congestion. Furthermore, Block 112 can determine how the congestion along a given road segment would improve if that driver was removed from the traffic congestion prediction to reduce the number of vehicles traveling per segment of that route.

In another example, Block 114 computes the contribution to congestion for a driver that is traveling along a new route segment that does not appear in the historic driver route database (Block 110). To calculate the contribution to congestion under these circumstances, Block 114 performs a sampling technique to determine the individual contribution to the future prediction of traffic congestion.

With the sampling technique, a representative sampling of driver scenarios along routes available from the historical driver route database (Block 114) and drivers' composition, including at least one of a routine travel route, travel route timing, vehicle dynamics, demographics or parking information, from the historical congestion database (Block 108) are provided to a simulator within Block 112. The simulator produces a simulation of how the driver traveling along the new route would behave in terms of predicted vehicle dynamics based on the sampling of driver scenarios and the composition of other drivers that have previously traveled along that route. The sampling technique can then output a driver's individual contribution to congestion for the new route.

In a further example, a driver's contribution to congestion is determined through a supervised machine learning (ML) model at Block 112 for a driver that is traveling along a route that does not appear in the historic driver route database (Block 110). The ML model receives driver compositions available for a given driver along multiple routes from the historical driver route database (Block 110) as well as driver compositions for other drivers from the historical congestion database (Block 108). The driver compositions for the other drivers can be for the same route as the future route or a different route similar to the future route based on traffic congestion levels. The ML model can then model the association between the driver composition for the given driver and the congestion level.

The ML model can then use the historical congestion data (Block 108) to determine a congestion related driving behavior model. The congestion related driving behavior model describes a model driver that does not contribute to congestion. In one example, the model driver can provide a baseline for comparison to other drivers. Block 112 can then quantify a “distance” that each of the drivers are from the model driver by determining a difference between the model driver and the other drivers. This quantification represents how the driver will contribute to traffic congestion. The greater the “distance” determined for an individual driver, the greater the contribution the individual driver makes to the congestion levels.

Once the driver contribution computations have been performed for the plurality of drivers, the drivers are ranked based on their individual contribution to traffic congestion along future trip paths (Block 112) to determine which of the drivers have the highest individual contribution to at least one congested road segment within the road network. This allows the method 100 to determine where the individual drivers will contribute to traffic congestion and each driver's individual contribution to the traffic congestion for a given route.

The inventive predictor 104 of the method 100 predicts an incentive that will convince the drivers not to operate the motor vehicle for a given day or period of time within the day. A driver utility model 120 receives preferences of the drivers (Block 118) and the drivers' response history (Block 116). The drivers' preferences can include at least one of driver demographics, routine travel routes, or a preference between being provided a monetary offer, being offered an alternative mode of transportation, or being offered the opportunity to stay at home in order not to contribute to traffic congestion.

The drivers' response history (Block 116) can include a history of the offers that were extended to the drivers and a record of the offers that were accepted by the drivers. The drivers' response history can also include the context for the offers that were made. In particular, the context can include at least one time of day of the future travel route, weekday of the future travel, location of the future travel, and a frequency that the driver travels along the future travel route.

With this information, the method 100 estimates the utility of driving for each of the drivers at Block 120. The utility estimation for each of the drivers quantifies the level of utility each driver places on operating the vehicle along the future travel route. In particular, the estimation determines the utility of minimal monetary offer, which can be learned from demographic information, and context of the future travel route (e.g., day of the week or destination of the future travel route, such as a school).

The method 100 then utilizes an offer utility solver at Block 122. The offer utility solver utilizes the estimation of the driver utility to determine a minimum offer that will exceed the driver utility such that the driver will not operate the vehicle along the at least one congested road segment in the road network.

The method 100 then performs an optimization (Block 106) based on the minimum offer determined for the driver to avoid operating the vehicle and the drivers' individual contribution to the future traffic congestion levels. The optimization solves for the minimum offer needed to achieve a desired reduction in the future traffic congestion levels. EQ. 1 below illustrates an example equation for an optimization of congestion at minimal cost. ΔSLA (t,c) provides the required relief to keep a certain service level agreement (SLA) at time/(#vehicles/time). Also, MarginalCongestion (d,c) predicts the individual congestion contribution for a driver d and context c (#vehicles/time). MinimalIncentive (d,c) provides the minimal incentive above which driver d is likely to avoid traveling in context c (price*time/#vehicles). The optimization goal is to minimize EQ. 1 such that La MinimalIncentive (d,c)>ΔSLA (t,c) for each context and time.

$$\\ \begin{matrix}min {\sum }_{c , t}^{Δ SLA} {\sum }_{d} MinimalIncentive ( d , c ) & EQ . 1\end{matrix}$$

FIG. 3 illustrates an example driver utility versus congestion graph 200. As shown in FIG. 3, a utility of traveling 202, such as commuting, decreases as a function of congestion (number of vehicles per unit time traveling along a road segment). In one example, the utility u is the benefit the driver receives from traveling or the benefit the driver receives from accepting an offer 206 not to travel. At some point 204 along the utility of traveling 202, the utility the driver gains from traveling along the future travel route becomes less than the utility the driver would receive from accepting the offer 206 to avoid traveling along the future travel route.

FIG. 4 illustrates an example utility u versus offer graph 300. As shown in FIG. 4, a utility of the offer 302 increases with increasing offer levels up until a cap 304 on the offer. There is also a point 306 where the offer 308 is sufficiently high enough to ensure the likelihood that the driver will accept it to avoid traveling. While the offer amount could be monetary in FIG. 4, the offer could also include an alternate form of transportation, such as a ride share, that reduces a number of vehicles on a specific route.

The optimization performed at Block 106 outputs which drivers accepted the offer not to take the future travel route and which drivers rejected the offer. This information is transferred along communication pathway 124 to be stored in the drivers' response history at Block 118.

Furthermore, a list of the drivers that accepted the offer to avoid travel in the vehicle is sent to the congestion predictor at Block 110 along communication pathway 126. The congestion predictor at Block 110 can then update the future traffic congestion levels by removing the individual contribution of each of the individual drivers that accepted the offer to determine updated future congestion levels. The driver contribution computation at Block 114 can then rank the remaining drivers based on their contribution to the future traffic congestion levels. This ranking is also associated with the future travel routes the driver will be traveling to determine each of the drivers' individual contribution to the future traffic congestion along the future travel routes.

This information is then sent to Block 106 for further optimization. In particular, the optimization performed at Block 106 will determine if the routes the drivers are traveling along require further reductions in traffic congestions. The optimization will also offer higher incentives to drivers with high rankings based on their individual contributions to traffic congestion. The method 100 will continue to iterative the above approach to reduce traffic congestion with additional offers until each of the drivers accepted the offers, a sufficient number of drivers accepted the offer not to take the future travel route, or there are no additional incentives available to offer to the drivers.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of reducing traffic congestion for a road network, the method comprising:
predicting future traffic congestion levels for the road network based on historical traffic congestion levels for the road network;
predicting an individual contribution to the future traffic congestion levels for each of a plurality of drivers based on future routes corresponding to each of the plurality of drivers, wherein the future routes include at least one road segment through the road network;
identifying at least one congested road segment based on the future traffic congestion levels for the road network;
identifying the plurality of drivers with a highest individual contribution to the at least one congested road segment; and
providing the plurality of drivers with the highest individual contributions to the at least one congested road segment a first offer to avoid operating a vehicle on the road network.

2. The method of claim 1, wherein the individual contribution to the future traffic congestion levels is determined based on historical driver route information.

3. The method of claim 2, wherein the historical driver route information includes at least one of a routine travel route, travel route timing, vehicle dynamics, or parking information recorded for each of the plurality of drivers associated with a route segment that corresponds to the future routes.

4. The method of claim 3, wherein the route segment corresponds to a new route segment not found within the historical driver route information.

5. The method of claim 4, including predicting driver route information for the new route segment based on the historical driver route information for other route segments in the road network.

6. The method of claim 1, wherein the first offer includes at least one of monetary compensation or an alternative mode of transportation.

7. The method of claim 1, wherein identifying the plurality of drivers with the highest individual contribution to the at least one congested road segment includes ranking the plurality of drivers by their individual contribution and providing at least one having a highest ranking the first offer.

8. The method of claim 7, wherein the first offer is provided to the plurality of drivers having a highest ranking having corresponding future routes through the road network having a highest level of congestion as determined by the future traffic congestion levels.

9. The method of claim 1, including determining a first set of the plurality of drivers that accepted the first offer and updating the future traffic congestion levels by removing the individual contribution to the future traffic congestion levels for the first set of the plurality of drivers to determine updated future traffic congestion levels.

10. The method of claim 9, including identifying a remaining set of the plurality of drivers that did not accept the first offer having the highest individual contribution to the updated future traffic congestion levels.

11. The method of claim 10, including providing the remaining set of the plurality of drivers a second offer if the corresponding future travel routes correspond to at least one congested road segment in the updated future traffic congestion levels.

12. The method of claim 1, wherein the future traffic congestion levels are defined in terms of a number of vehicles traveling per unit time over a predetermined road segment in the road network.

13. The method of claim 12, wherein the individual contribution to the future traffic congestion levels for each of a plurality of drivers is defined in terms of a number of vehicles traveling per unit time over a predetermined driver road segment in the road network.

14. The method of claim 1, wherein the first offer is determined based on a driver utility of travel for each of the plurality of drivers traveling along the at least one congested road segment.

15. The method of claim 14, wherein the first offer exceeds the driver utility of travel for each of the plurality of drivers traveling along the at least one congested road segment.

16. A non-transitory computer-readable medium embodying programmed instructions which, when executed by a processor, are operable for performing a method comprising:
predicting future traffic congestion levels for a road network based on historical traffic congestion levels for the road network;
predicting an individual contribution to the future traffic congestion levels for each of a plurality of drivers based on future routes corresponding to each of the plurality of drivers, wherein the future routes include at least one road segment through the road network;
identifying at least one congested road segment based on the future traffic congestion levels for the road network;
identifying the plurality of drivers with a highest individual contribution to the at least one congested road segment; and
providing the plurality of drivers with the highest individual contributions to the at least one congested road segment a first offer to avoid operating a vehicle on the road network.

17. The computer-readable medium of claim 16, wherein the individual contribution to the future traffic congestion levels is determined based on historical driver route information.

18. The computer-readable medium of claim 17, wherein the historical driver route information includes at least one of a routine travel route, travel route timing, vehicle dynamics, or parking information recorded for each of the plurality of drivers associated with a route segment that corresponds to the future routes.

19. The computer-readable medium of claim 18, wherein the route segment corresponds to a new route segment not found within the historical driver route information and predicting driver route information for the new route segment based on the historical driver route information for other route segments in the road network.

20. A system for reducing traffic congestion on a road network, the method comprising:
a vehicle having a plurality of sensors;
a controller in communication with the plurality of sensors, the controller having a processor and tangible, non-transitory memory on which instructions are recorded, the controller being configured to:
predict future traffic congestion levels for the road network based on historical traffic congestion levels for the road network;
predict an individual contribution to the future traffic congestion levels for each of a plurality of drivers based on future routes corresponding to each of the plurality of drivers, wherein the future routes include at least one road segment through the road network;
identify at least one congested road segment based on the future traffic congestion levels for the road network;
identify the plurality of drivers with a highest individual contribution to the at least one congested road segment; and
provide the plurality of drivers with the highest individual contributions to the at least one congested road segment a first offer to avoid operating a vehicle on the road network.
